(19) United States
(12) Patent Application Publication
(10) Pub. No.: US 2026/0359084 A1
(43) Pub. Date: Nov. 12, 2026

(54) GENERALIZED INTERMEDIATE AND LOWER LEVEL SOURCE CODE REPRESENTATIONS FOR STATIC APPLICATION SECURITY TESTING

(71) Applicant: MICRO FOCUS LLC, Wilmington, DE (US)

(72) Inventors: Er-Xin Shang, Shanghai (CN); Fei Gao, Shanghai (CN); Yan-Jun Yu, Shanghai (CN); Peter Raymond, London (GB)

(21) Appl. No.: 19/630,250

(22) Filed: Mar. 26, 2026

Related U.S. Application Data
(63) Continuation of application No. 17/201,726, filed on Mar. 15, 2021, now abandoned.

(51) Int. Cl. G06F 9/451; G06F 3/04817; G06F 3/0482; G06F 3/04842; G06F 3/16; G06F 40/263; G06N 20/00; G10L 13/08

(52) U.S. Cl. CPC G06F 9/453; G06F 3/04817; G06F 3/0482; G06F 3/04842; G06F 3/167; G06F 40/263; G06N 20/00; G10L 13/08

(57) ABSTRACT

Systems and methods of automatically generating a video are described. Systems and methods include receiving a test script, generating a step action tree comprising a plurality of actions based on the test script, receiving a selection of a first action of the plurality of actions in the step action tree, and based on the selection of the first action, generating a video clip of a graphical user interface performing the first action and associating the multimedia clip with the first action.

### FIELD

The present disclosure relates generally to user interfaces and more particularly to generating tutorial videos.

### BACKGROUND

Computer systems, such as personal computers and smartphones, execute user applications in which users interact with graphical user interface (GUI) elements displayed on a user interface. Such applications include, for example, Internet browsers used to view websites and applications such as word processing applications. Applications can include those that execute on the same computing devices on which users interact with the applications, like applications running on computing devices such as smartphone, tablet, and more traditional laptop and desktop computing devices. The applications can further include those that primarily execute on one computing device, like a server computing device, and with which users interact via another computing device, like a client computing device that may be a smartphone, tablet, or a more traditional computing device. The latter applications can include web applications, or web apps, which can run within web browser programs on the client side.

When a user installs a new application or visits a website for the first time, the user may be confronted with one or more features with which the user is unfamiliar. Often, rather than attempting to understand by trying or reading a manual as to how to use new features, a user may instead view a tutorial video. Tutorial videos may be useful to visualize and learn how to use new features of an application or website.

As the software used to execute such user applications is developed and updated over time, new features are often added. With new features, new tutorial videos may be created.

While tutorial videos are a great benefit to end users, the creation of tutorial videos is often a time consuming and inefficient process. For example, a software developer may execute a screen capture application to record his or her screen, including mouse movements and the entry of text, to illustrate a new feature. The developer may use a voice recording software to talk through the steps being performed. The screen capture video must typically be edited to remove mistakes or unnecessary time delays. Similarly, the audio of the developer talking through the steps may be edited or replaced with the recording of additional audio. Furthermore, with each new iteration of a new feature or change in an application or website, older tutorial videos must be updated or recreated, resulting in a highly inefficient process for showing end users how to use an application or website.

### BRIEF DESCRIPTION OF THE DRAWINGS

FIG. 1 is an illustration of a computing environment in accordance with one or more of the embodiments described herein;

FIGS. 2A-2C are illustrations of user interfaces of an application in accordance with one or more of the embodiments described herein;

FIG. 3 is an illustration of a user interface of an application in accordance with one or more of the embodiments described herein;

FIG. 4 is an illustration of a still image of a video in accordance with one or more of the embodiments described herein;

FIG. 5 is an illustration of user interface of an application in accordance with one or more of the embodiments described herein; and

FIGS. 6A-6C is a flowchart of a method in accordance with one or more of the embodiments described herein.

Wherever possible, the same reference numbers will be used throughout the drawing(s) and accompanying written description to refer to the same or like parts.

### DETAILED DESCRIPTION

As discussed in the background, tutorial videos are a great benefit to end users, but the creation of tutorial videos is a time-consuming process. What is needed is an automated system for creating tutorial videos which may be used by software or web developers to automatically create new tutorial videos with any new update to features of an application or website.

The systems and methods described herein involve creating tutorial videos for applications or websites or any type of system in which users interact with graphical user interface (GUI) elements displayed on a user interface. For simplicity of explanation, the term application as used herein may refer to a computer application, a mobile application, a website, or any other type of computer system involving software and GUI elements.

As noted in the background, when using an application, users interact with GUI elements displayed by the application to cause the application to perform a desired function. There is a large variety of GUI elements which can be deployed by an application. For example, GUI elements used by an application may include, but are not limited to, text boxes which can be selected by a user which can allow text to be entered, radio buttons, dropdown list boxes that permit the user to select from one or more different options corresponding to the radio buttons and list box items, and checkboxes that permit a user to select from multiple options corresponding to the checkboxes. As other non-exhaustive examples, GUI elements can include toggle switches that permit the user to select from two options, and action buttons that the users can affirmatively select to perform actions like submit, cancel, and so on.

As described herein, systems and methods may comprise a method of generating tutorial videos for a client application autonomously or with or without the aid of a human developer. The systems and methods described herein provide a tool for developers to create tutorial videos for client applications in a way heretofore impossible. The systems and methods described herein amount to a tool for making video material in such a way as to make the creation of video material more efficient and user friendly then before possible. Using these systems and methods described herein, a developer may be enabled to create tutorial video material more quickly, accurately, and easily then before possible. Developers, using systems and methods as described herein, may be able to generate more tutorial video material then possible before without the use of such systems and methods described herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a,” “an,” “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “means,” as used herein, shall be given its broadest possible interpretation in accordance with 35 U.S.C. § 112 (f) and/or § 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

As described herein, a developer application may be used to create a tutorial video for a client application. The developer application may also be referred to as a test tool. The client application may also be referred to as an application under test (“AUT”). As described herein, an AUT may be a web application or a native application. An AUT may be any type of computer software that employs GUI buttons or other user-interactive elements.

In general, a tutorial video may be a set of still images and/or video clips. Each still image or video clip may be a scene of a tutorial video. Each scene of a tutorial video may include an illustration of an action which a user may perform using a GUI element of a UI along with a textual and/or audio explanation. For example, a tutorial video may include a scene instructing a user to click a button labeled book. The scene may include the words “click the book button” along with a still image of a mouse cursor over the book button or with a video of the book button being clicked. The words may be alternatively or additionally spoken. The tutorial video may also include background music, a title scene, and end scene, and other elements as should be understood by a person of skill in the art.

The developer application may be a software application in which a user may load or access an AUT. As described herein, the user may open the developer application and select an AUT for which to create a tutorial video. A user interface of the AUT may be displayed alongside a UI of the test tool. The user may use the developer application, as described below, to select a set of actions which are to be illustrated in the tutorial video.

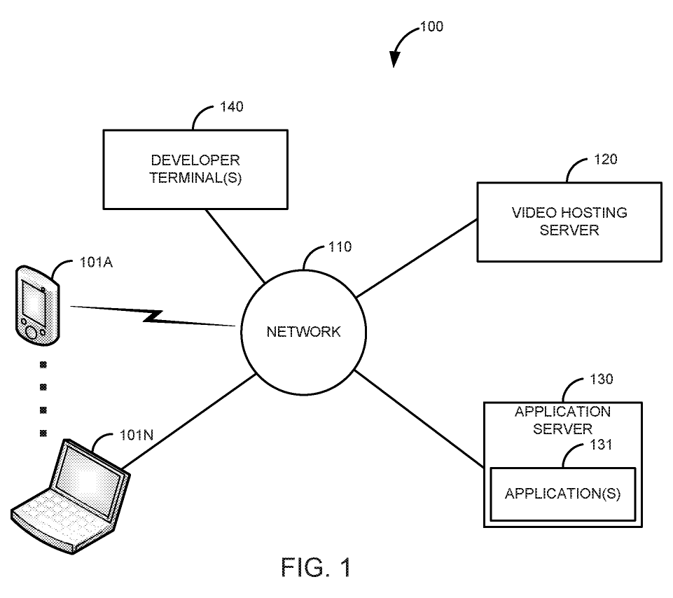

FIG. 1 is a block diagram of an illustrative system 100 for generating tutorial videos. The system 100 may be accessed by one or more user devices 101A-101N. The illustrative system 100 may comprise the user devices 101A-101N, a network 110, a video hosting server 120, an application server 130 with access to or hosting one or more applications as described herein, and one or more developer terminals 140.

User devices 101A-101N can be or may include any user communication endpoint device that can communicate on the network 110, such as a Personal Computer (PC), a tablet device, a notebook device, a smart phone, and/or the like. User devices 101A-101N may be used to access any one or more of the video hosting server 120, application server 130, and developer terminals 140. As shown in FIG. 1, any number of communication devices 101A-101N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), a combination of these, and the like. The network 110 can use a variety of electronic protocols, such as Ethernet, Internet Protocol (IP), Session Initiation Protocol (SIP), Integrated Services Digital Network (ISDN), and the like. Thus, the network 110 is an electronic communication network configured to carry messages via packets and/or circuit switched communications.

The video hosting server 120 can be or may include any hardware system that can facilitate communications on the network 110, such as a session manager, a communication manager, a proxy server, a Private Branch Exchange (PBX), a central office switch, a router, and/or the like. The video hosting server 120 may comprise one or more memory storage elements capable of storing audio and/or video information as described herein.

The application server 130 can be or may include any hardware system that can host applications 131, such as a web server, a media server, and/or the like. In one embodiment, the application server 130 may be part of the video hosting server 120 and/or the developer terminal 140.

The application(s) 131 can be any application to be used as an AUT to create a tutorial video, such as a recording application, a calendar application, a video application, a web browser application, an Instant Messaging application, an email application, a call screening application, a conferencing application, and/or the like. As described herein, application may also refer to a website or mobile application. The applications 131 may communicate via an Application Programming Interface (API). For example, the API may be an Extended Markup Language (XML) interface, a Java Speech API (JSAPI) application, and/or the like.

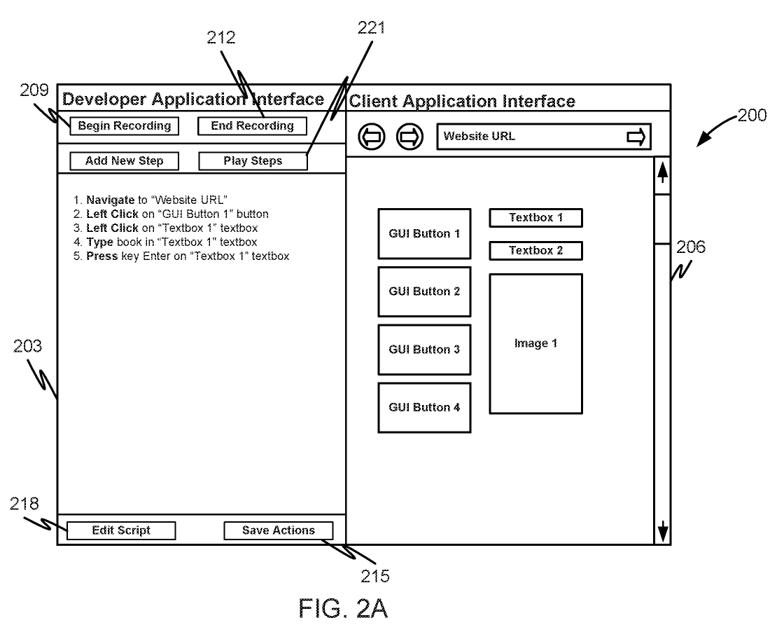

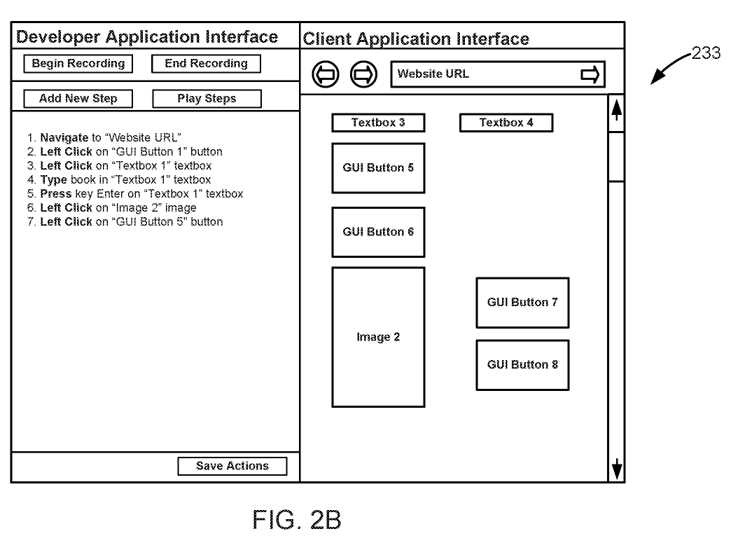

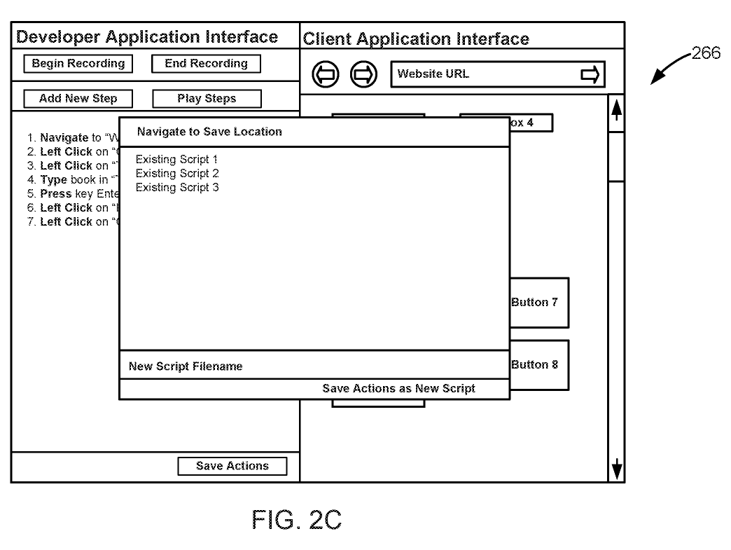

A developer application may comprise a user interface 200 as illustrated in FIG. 2A. The user interface 200 may comprise a developer pane 203 and a client application or AUT interface pane 206. The developer pane 203 may comprise a set of graphical user interface buttons with which a user of the developer application may interact.

The AUT interface pane 206 may comprise a display of a user interface of the AUT as if the user of the developer application is using the AUT itself. In some embodiments, upon opening the developer application, a user may be presented with a menu for selecting an AUT for which to develop a tutorial video. The user may select from among a selection of AUTs or may load an AUT in another way. While the AUT of FIG. 2A is illustrated as a webpage, it should be appreciated the AUT can be any type of application, for example a word processing application or an instance of a developer application as described herein.

After an AUT is selected, the UI of the AUT may be displayed in the AUT interface pane 206. The developer application may next process the AUT UI to locate and identify any user-interactable elements in the UI. For example, any GUI buttons, textboxes, images, and the like, may be identified.

A user of the developer application may be capable of interacting with an AUT through the AUT interface pane 206. For example, the user of the codeveloper application may interact with any GUI elements of the AUT as if the user is using the AUT as normal.

The developer pane 203 may comprise a begin recording GUI button 209. Clicking the begin recording GUI button 209 may begin a logging process. After clicking the begin recording GUI button 209, any interaction in the AUT interface pane 206 may be logged in the developer pane 203. In the example developer application 200 of FIG. 2A, the AUT is a browser window. After clicking the begin recording GUI button 209, the user may enter a website URL in the browser address bar and hit enter. The developer application may recognize this action as navigating to the website URL and may log the action in the developer pane 203 as illustrated by step 1 in the developer pane 203 of FIG. 2A. After the website URL webpage loads, the user may then left click on a GUI button. The developer application may be enabled to recognize a click of a mouse button and detect which GUI button was clicked. In the example illustrated in FIG. 2A, the user clicked on a GUI Button 1. The developer may log the action in the developer pane 203 as a step 2, “Left Click on ‘GUI Button 1’ button” as illustrated in FIG. 2A.

In this way, the developer action may log a series of actions performed by a user. Whether a user clicks or types or otherwise interacts with GUI elements of the AUT, the user’s actions may be recognized and logged by the developer application.

As illustrated in FIG. 2B, as the UI 233 of the AUT changes, the developer pane 203 may continue to log the steps performed by the user. When the user decides to stop logging his or her steps, the user may click an end recording GUI button 212 in the developer pane 203. The user may also click a save actions GUI button 215 to save the recorded actions as a new action list, action script, or action tree as described herein. Clicking a save actions GUI button 215 may prompt the display of a save file navigation window, enabling the user of the developer application to save the script as a new file.

In some embodiments, as illustrated in FIG. 2A, the developer pane 203 may comprise an edit script GUI button 218. The edit script GUI button 218 may enable a user of the developer application to remove one or more steps from the script, return to a previous step to continue from the previous step, overwriting next steps, or edit the script in other ways. For example, if the user makes a mistake while performing actions, the user can simply return to a previous step and continue from the previous point.

In some embodiments, as illustrated in FIG. 2A, the developer pane 203 may comprise a play steps GUI button 221. The play steps GUI button 221 may prompt the developer to automatically proceed through the steps, performing each action. For example, in the script illustrated in FIG. 2A, the developer application may be capable of automatically performing the steps of navigating to the website URL, left clicking on the graphical user interface button labeled GUI Button 1, etc. The developer application may automatically move the mouse cursor in the AUI interface pane while performing the actions of the script.

Using a system as described herein, scripts of actions may be created in an intuitive manner by recording the actions of a user. As described herein, a script may comprise one or more actions. Each action may be an action performed or performable by a user of an AUT. To create a tutorial video, a user may record him or herself interacting with an AUT via a developer application performing the actions to be presented during the tutorial video.

The process of creating a script of actions may begin with a user of a developer application opening a window containing the user interface of the target application or AUT. The user may click a record button, though this may not be necessary. Upon the developer application opening the AUT, the developer application may identify all GUI elements in a user interface. The process of identifying all GUI elements in the user interface may be an ongoing process during the time that the AUT is open within the developer application.

The process of recording steps of the user using the developer application may include detecting the interaction of the user with the GUI elements within the AUT. For example, if a user clicks on a GUI element, the action may be recorded as a step, e.g., “Click on [All Departments] text box.” The recording of such an action may comprise detecting the click, detecting the GUI element being clicked, and recording such information in the list of action steps. As a second example, if a user types a text string, the action is recorded as a step, e.g., “Type ‘Book’ in [All Departments] text box.” The recording of such an action may comprise detecting the input of text, detecting the GUI element being typed into, and recording such information in the list of action steps. As a third example, if a user presses the “Enter” key, the action may be recorded as a step, e.g., “Press key Enter on [All Departments] text box.” The recording of such an action may comprise detecting the press of the “Enter” key, detecting the GUI element being activated by the press of the “Enter” key, and recording such information in the list of action steps.

In some embodiments, the developer application may operate in a background manner. For example, as users interactive with an AUT normally, a client action recorder may be used to record the actions performed by the user. A script may be created in this way similar to the way described above in relation to FIGS. 2A-2C.

Each script may be stored in memory accessible by the developer application. A script may be considered as being a flow of actions. For each AUT, a plurality of scripts may be created to illustrate a number of features of the AUT. It should be appreciated that each script for a particular AUT may overlap with one or more other scripts.

For example, the AUT illustrated in FIGS. 2A-2C involves a webpage. Navigating to the webpage URL may be a first action of a plurality of scripts for the AUT. Similarly, left clicking on the GUI Button 1 button may be a second action of a plurality of scripts. At each point during the performance of a script, a new action may be performed.

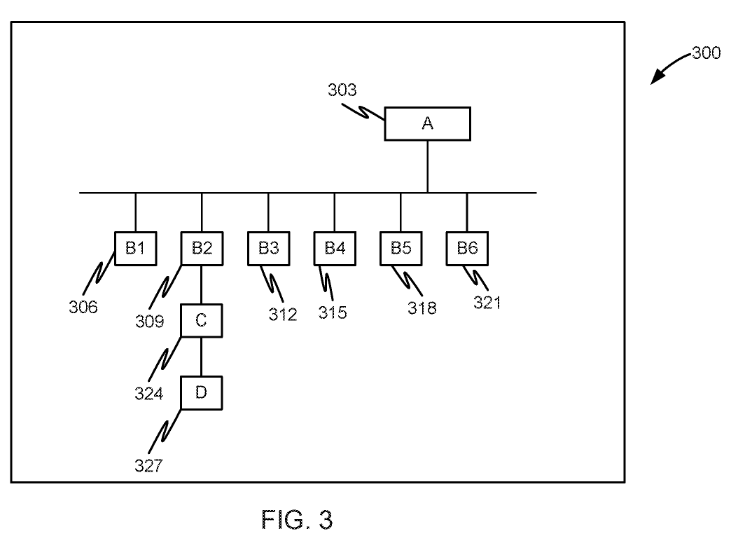

The developer application may be configured to present a user interface 300 as illustrated in FIG. 3 to a user to illustrate the overlapping nature of the scripts for a particular AUT. Each box 303, 306, 309, 312, 315, 318, 321, 324, 327 may illustrate an action performable in the AUT. The boxes 303, 306, 309, 312, 315, 318, 321, 324, 327 may be arranged in a manner such that earlier steps are laid out above later steps with lines connecting earlier steps to next steps. For example, after a step A 303, any of steps B1 306, B2 309, B3 312, B4 315, B5 318, and B6 321 are possible. After step B2 309, step C 324 may be performed and after step C 324, step D 327 may be performed. In this way, an action tree may be generated in a user-friendly manner to enable a user to quickly see an action and to determine what preceding actions lead to that action and what actions are possible following that action.

To illustrate in conjunction with FIGS. 2A-2C, step A 303 may be a step of navigating to the webpage URL and steps B1-B6 306, 309, 312, 315, 318, and 321 may be interactions with the GUI buttons presented on the webpage URL. If B2 209 represents clicking on GUI Button 1, C 224 may be clicking on a GUI button presented after GUI Button 1 is clicked.

The actions in the tree may be displayed as the GUI elements or other features with which the actions are associated. For example, an action for clicking on GUI Button 1 may display an image of the GUI Button 1 as would be displayed in the UI of the AUT.

It should be appreciated that in some embodiments an action may be one or more steps, such as click a GUI button or click a GUI button and type a text string. More complex actions may involve many steps, such as click a first GUI button, type a text string, click a second GUI button, wait for a web page to load, scroll down the web page, click a third GUI button. Each action of a complex string of actions may be considered individually. Linking each action together can create an action tree. For example, clicking a first GUI button may enable a large set of possible actions, one of which being type a text string. Each possible action enabled by clicking the first GUI button may be a branch of an action tree beneath the first action of clicking the first GUI button.

Similar to the way in which one action may comprise one or more distinct actions, one action tree may comprise smaller action trees. For example, one box of an action tree may represent a plurality of actions which may, in and of themselves, be an action tree. Similarly, one action tree may comprise all possible actions for a particular AUT.

In some embodiments, the developer application may operate in an automated manner. For example, scripts may be created automatically by the developer application. For example, a computer system may be enabled to iteratively process each possible user action and save those actions as branches of the action tree. The process of creating the action tree may execute until every conceivable user action has been performed and logged in the form of an action tree.

The developer application may be capable of identifying the type of user action necessary to perform each action. For example, the developer action may be capable of recognizing and simulating movement and clicks of a mouse and typing of text.

A text string identifying the type of action may be automatically created by the application. Each action may be labeled based on the type of action to be performed by the user. Each step of the action tree may be associated with a text string identifying the type of action. For example, an action of clicking a GUI button labelled “Search” may be associated with a text string of “CLICK SEARCH BUTTON.” An action of typing the word “Book” may be associated with a text string of “TYPE ‘Book’.” An action of typing the word “Book” into a “SEARCH” text box may be associated with a text string of “TYPE ‘Book’ IN SEARCH.” The developer application may be configured to automatically create the text string identifying the type of action.

To generate a tutorial video in accordance with the embodiments described herein, the developer application may be capable of creating a video clip of an action. The developer application may be capable of simulating the performance of each action in an action tree. For example, an action may be as simple as clicking a GUI button. The developer application may be capable of simulating a mouse movement to place a cursor over the GUI button identified by the action and performing a clicking action as if a user physically moved and clicked the mouse. The developer application may also be capable of simulating more complex steps. For example, an action may comprise multiple steps, such as click a GUI button, type a word, click another button. The developer application may be capable of simulating user performing those actions.

The developer application may simulate the performance of such actions and record the screen as a video clip or may simply generate a video file containing a simulation of the performance of the actions. In some embodiments, the video may be enhanced for user-friendliness such as by including a circle around the mouse cursor or text cursor or insertion point. In some embodiments, the video may be a zoomed-in perspective of the mouse cursor to highlight the action being performed.

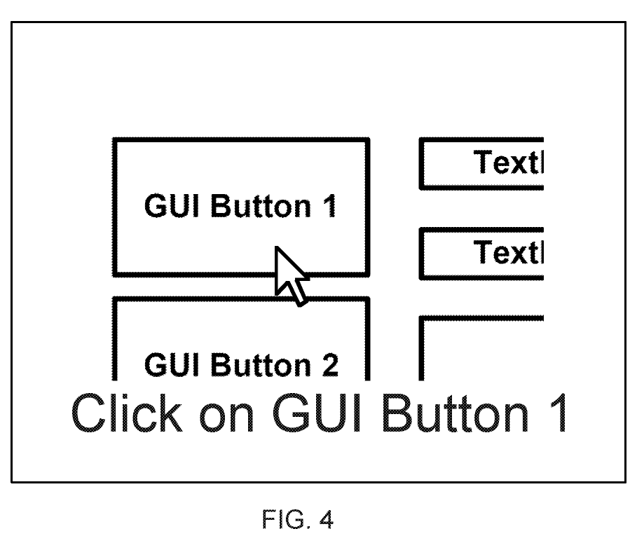

In some embodiments, the tutorial video may comprise a number of still images created in a similar way. For example, as illustrated in FIG. 4, a clip of a tutorial video for an action of clicking a GUI button may consist of a zoomed in look of a cursor floating over the GUI button. Text, as discussed herein, may be added to further instruct a user watching the video as to the action being performed.

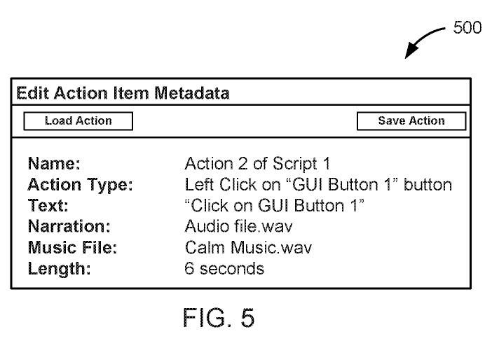

Each video clip, or still image, (“clip” as used herein) may be stored in memory. The clip may be stored in memory along with the graphical illustration of the action trees as described in relation to FIG. 3. Each clip may be accompanied by metadata. Metadata for each clip may contain additional information such as clip length, audio for the clip, text for the clip, music for the clip, a name for the clip, and/or other information. As illustrated in FIG. 5, a user interface 500 may be presented to a user of the developer application to enable the user to edit any one of the one or more items in the metadata for a particular action.

The name of a clip may be set automatically based on the action being performed. For example, an action to click on GUI Button 1 may be named “Click GUI Button 1.” As illustrated by the actions in the script in the developer pane of FIG. 2A, names of clips may be the text shown in the script. For example, “Navigate to ‘Website URL,’” “Left Click on ‘GUI BUTTON 1’ button,” “Left Click on ‘Textbox 1’ textbox,” etc.

The clip length may be set automatically by the developer application. The clip length may be set based on a type of action being performed. For example, the clicking of a GUI button may be preset to three seconds while the typing of a word may be preset to six seconds. The clip length may be set manually by a user of the developer application. For example, a user of the developer application may be enabled to set a length for each clip individually. The length of the clip may be used when creating a tutorial video, as described herein, to determine how long to display the clip during the tutorial video. In the case of the clip being a video, the length may be used to set a speed of the playback of the clip or may be used to set an amount of time to add on to the beginning or end of the video.

In general, test scripts may be optimized for speed and parallel execution, but for a tutorial video the steps need to be displayed at a speed which a viewer can follow. In some embodiments, metadata may be added to a test script to define a tutorial length of the script, e.g., a number of seconds. When generating the tutorial video, the developer application would honor the tutorial length setting to ensure the tutorial video runs in that time. For example, the developer application may insert sleep time or other delaying measures as necessary in between test steps.

Metadata for each clip may include a text string which may be presented during the presentation of the clip during the tutorial video. For example, for the clip illustrated in FIG. 4, the metadata may include a text string of “Click on GUI Button 1.” As described below, the text string for the metadata of a particular action may be generated automatically based on information associated with the action. Text for an action may also be set by a user of the developer application. For example, a user may be enabled, using the developer application, to specify what text should be displayed along with the action during the tutorial video.

In some embodiments, the text string identifying the type of action may be processed using an artificial intelligence or machine learning algorithm to make the text string more recognizable and understandable by a user. For example, an action titled “TYPE ‘Book’ IN SEARCH” may be processed by a machine learning algorithm which may output “Type the word ‘Book’ into the ‘Search’ text box.”

Metadata for each clip may include a link to an audio file which may be played during the presentation of the clip during the tutorial video. In some embodiments, narration of the clip may be automatically generated using a text-to-speech generator by converting the text string for the clip into audio. In some embodiments, users may be capable of adding to or replacing automatically generated audio. For example, the developer application may include a record button which may enable a user to add his or her own voice to a clip.

Metadata for each clip may also include a specification as to music to be played during the clip. In some embodiments, music may be set for a tutorial video as a whole or may be set separately for each individual clip. The metadata for the music may be a link to an audio file or may be another type of pointer towards a location of an audio file for the music.

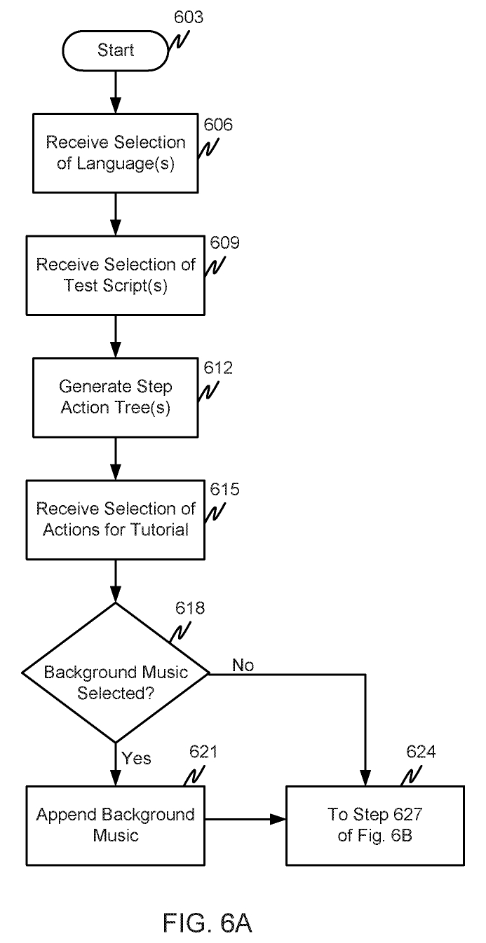

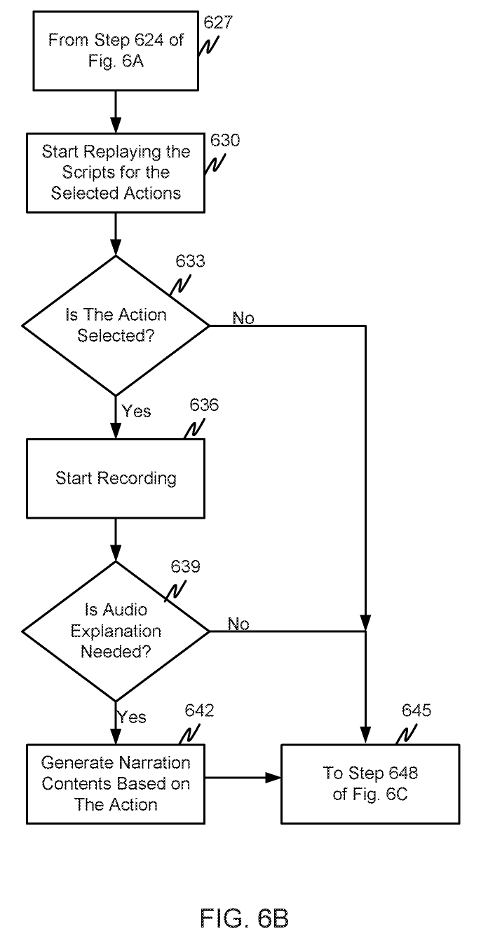

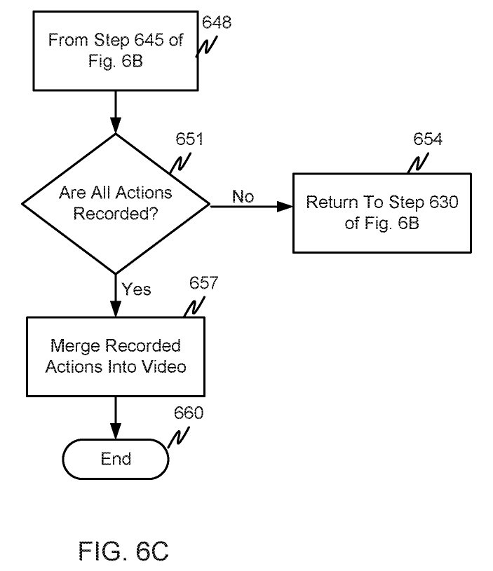

As illustrated by the flowchart of FIGS. 6A-6C, a method of automatically generating a tutorial video for an AUT may be enabled using a developer application as described herein. The method may begin at step 603 in which a user of a developer application selects an application to use as the AUT for which to create the tutorial video. As described herein, the developer application may be executing on a computing device. The AUT may be a web application or a native application. The AUT may be hosted by a server or may execute on the computing device executing the developer application. In some embodiments, an instance of the AUT may execute or be simulated within the developer application. While the steps of the method described herein are described in a particular order, the disclosure should not be considered as being so limited. Instead, the steps may be performed in any order and/or simultaneously as should be considered by one of skill in the art.

At step 606, the method may comprise receiving a selection of one or more languages in which to generate the tutorial video. In some embodiments, a language may be selected by a user of the developer application for example by using a dropdown box. A user may select within the developer application from among a plurality of languages. The user of the developer application may select multiple languages or one language. IN some embodiments, selecting multiple languages may result in the creation of multiple tutorial videos—one tutorial video for each language—or one tutorial video with multiple languages, e.g., using subtitles or multiple voiceovers.

At step 609, the method may comprise receiving a selection of one or more test scripts to be illustrated in the tutorial video. As described herein, users may use a developer application to generate one or more test scripts. A tutorial video may be created based on such test scripts. In some embodiments, a single test script may be used to create one tutorial video. In some embodiments, multiple test scripts may be combined into a single tutorial video. Using the developer application, a user may be enabled to select from a number of test scripts for the AUT from memory of the computing device executing the developer application. In some embodiments, users may be enabled to create one or more test scripts using the developer application as described above in relation to FIGS. 2A-2C.

At step 612, a step action tree may be generated based on the selected test scripts. As illustrated in FIG. 3, a step action tree may be a visual representation of one or more test scripts. If multiple test scripts are selected, any actions performed in two or more of the test scripts may be represented by a single box of the step action tree. In this way, a single step action tree may have multiple branches representing deviations between different selected test scripts.

At step 615, one or more actions of the step action tree may be selected for illustration in the tutorial video. By interacting with the step action tree, a user may be enabled to select which of the actions in the one or more selected test scripts should be illustrated in the tutorial video. In some embodiments, a user can select a beginning action and an ending action. For example, by selecting a beginning action and an ending action, the developer application may automatically select each of the actions in between the beginning and ending action so that the entire flow of action from the beginning action to the ending action is selected. In some embodiments, a user may select each action separately. For example, a user may interact with a step action tree as illustrated in FIG. 3 and select each of the actions which should be illustrated in the tutorial video. In some embodiments, a user may simply select an ending action. The developer application may be configured to automatically select all preceding actions leading to the selected ending action. In this way, by receiving a selection of one or more actions, the developer application may determine which actions should be in the tutorial video. The actions automatically selected by the developer application may be viewable and/or editable by the user of the developer application to determine the ultimate set of actions which are to be illustrated in the video.

At step 618, the developer application may determine whether background music is required for the tutorial video. In some embodiments, the choice of background music may be made by the user of the developer application. For example, the developer application may present a user interface to the user with a choice to select from or upload a file of background music. In some embodiments, background music may be determined automatically by the developer application based on metadata associated with one or more of the actions to be illustrated in the video. If one or more of the actions includes metadata associated with a background music, such music may be used for the video as a whole. Alternatively, each action may be associated with its own background music based on its own metadata.

At step 621, if background music is required, the developer application may append the background music to the video to be created. Appending the background music may comprise selecting a music file to be merged into the video as described below.

At step 624 of FIG. 6A, the method continues to step 627 of FIG. 6B. At step 627 of FIG. 6B, the method continues to step 630 in which the scripts for the selected actions may be replayed by the developer application. Replaying scripts for selected actions may comprise, as described herein, automatically performing or simulating the actions a user would make in performing the actions. For example, the developer application may be enabled to move the cursor within the AUT and enter text as if by a human user. As described above, mouse movements and text input may be highlighted with visual aids. Other key entries, such as an Enter key may be highlighted using on-screen text.

As the developer application proceeds through the performance of the actions in the test script, the developer application may determine, for each action, whether the instant action was selected for illustration in the tutorial video. At step 633 of FIG. 6B, a determination is made as to whether the instant action is a selected action. If the instant action is not a selected action, the method proceeds to step 645 of FIG. 6B and on to step 648 of FIG. 6C discussed below.

At step 636, if the instant action is a selected action, the developer application may begin a recording function and may begin performing the instant action. For example, a screen-capture function may be used to record the performance of the action. As should be appreciated, actions may be performed in the background and recorded in a way such that screen-capture is not necessary.

In this way, as the actions of the script are performed, a video clip may be created for each of the selected actions. In some embodiments, a video clip may comprise a zoomed-in view of a user interface performing an action. For example, a zoomed-in perspective of the mouse cursor may enable a close-up view of the action being performed. In some embodiments, a video clip may be performed or generated to be of a particular length of time based on metadata associated with each particular action. The developer application may be enabled to determine a length for each action automatically. For example, clicking actions may be a first length while text entry actions may be a second length. In some embodiments, the performance of the action may be slowed or sped up. As discussed above, a test script may be associated with metadata designating a video length. The developer application may perform each action at a particular speed to produce a tutorial video at a desired length.

At step 639 of FIG. 6B, the developer application may determine whether an audio explanation for the instant action is necessary. If no audio explanation is necessary, the method proceeds to step 645 of FIG. 6B and on to step 648 of FIG. 6C discussed below.

At step 642, if audio explanation is necessary, the developer application may generate narration contents for the instant action based on the action. For example, if the action is associated with metadata including a textual description of the action, generating an audio explanation may comprise processing the textual description with a text-to-speech engine. In some embodiments, as described herein, generating the audio explanation may further comprise first processing textual metadata associated with the action with a machine learning algorithm to improve the clarity of the text such as an AI text generation engine. For example, as discussed above, a text description of “click book GUI button” may be converted, using a machine learning algorithm, to “click the book button.” A text-to-speech or “TTS” engine may then convert the text description to an audio recording of spoken word. In some embodiments, a user may be enabled to decide whether auto-generated audio should be included. A user may also be enabled to add his or her own audio to one or more of the clips.

In some embodiments, metadata may be added to one or more actions of a test script to specify a narration text for the step. If such metadata is present, the developer application may use the narration text as opposed to or in addition to the textual description of the action.

In this way, the developer application may continue to perform each step of the script and to record each of selected actions. At step 645 of FIG. 6B, the method continues to step 648 of FIG. 6C. At step 648 of FIG. 6C, the method continues to step 651 of FIG. 6C in which the developer application determines whether all selected actions have been recorded. If not all the selected actions have been recorded, in step 654 the method returns to step 630 of FIG. 6B to continue recording actions as discussed above.

If each of the selected actions has been recorded, the method proceeds to step 657 of FIG. 6C in which the recorded actions are merged into one video. At this step, or at any point prior, the developer application can add the audio explanation, background music, text, or other elements to each clip. For example, each clip may be presented along with the textual description—for example as processed by a machine learning algorithm—and voiceover reading the same textual description as generated with a text-to-speech engine. It should be appreciated that in the case of multiple languages being selected for the tutorial video, the steps of adding audio explanation and text to each video clip may be repeated for each language.

In some embodiments, the developer application can link each recorded clip together. For example, the developer application may add transitions between each clip, such as a fade or sliding action, to improve viewability. The developer may also add a title clip, such as a video clip including a title for the tutorial video. For example, a title may be selected automatically based on the last action of the tutorial video or may be selected manually by a user. The developer application may name the tutorial video and save the tutorial video as a video file. In some embodiments, the video may be converted to a GIF file or other animation type filetype for integration into documents. Similarly, the developer application may add an ending or conclusion video clip. In some embodiments, a text version tutorial may also be generated. For example, a PDF or other type of document may be created with still images from each clip along with the textual description. Such a document may be saved along with or instead of the video. At step 660 of FIG. 6C, the method may end, at which point a tutorial video file may be output by the developer application for distribution.

In some embodiments, additional text may be included for display during the video. For example, tutorial videos produced by development teams often include some introductory text such as an explanation of value provided by the new features, a business case enabled by the new features, some information about why a customer should follow the steps in the tutorial. As such, additional text describing each test script may be defined. Users may be enabled to add text to be displayed in the form of a video clip or still image. Text added by users may be processed using the AI and/or TTS features described herein such that audio may be produced. The text may be presented, for example, in a bullet point form during, prior to, or after the video along with audio narration.

As described herein, embodiments of the present disclosure include a method of automatically generating a video, the method comprising: receiving, with a processor of a computer system, a test script; generating, with the processor, a step action tree comprising a plurality of actions based on the test script; receiving, with the processor, a selection of a first action of the plurality of actions in the step action tree; and based on the selection of the first action: generating, with the processor, a first video clip of a graphical user interface performing the first action; and associating, with the processor, the first video clip with the first action.

Aspects of the above method include the method further comprising generating text for the first action.

Aspects of the above method include wherein the text is generated using a machine learning algorithm.

Aspects of the above method include wherein a description of the first action is used as an input to the machine learning algorithm and the text for the first action is an output of the machine learning algorithm.

Aspects of the above method include the method further comprising, generating a narration audio clip for the first action.

Aspects of the above method include wherein the narration audio clip is generated by processing the text for the first action using a text-to-speech engine.

Aspects of the above method include the method further comprising appending the narration audio clip to the first video clip.

Aspects of the above method include the method further comprising, prior to generating text for the first action, receiving a selection of one or more languages.

Aspects of the above method include wherein generating text for the first action comprises generating a text string in each of the one or more languages.

Aspects of the above method include the method further comprising generating a separate video clip for the first action for each of the one or more languages.

Aspects of the above method include the method further comprising determining a plurality of preceding actions based on the selection of the first action.

Aspects of the above method include the method further comprising generating a video clip for each of the plurality of preceding actions.

Aspects of the above method include the method further comprising generating a video file comprising each video clip for each of the preceding actions and the first video clip.

Aspects of the above method include the method further comprising appending music to the first video clip.

Aspects of the above method include wherein generating the step action tree comprises recording, with a developer application, a user interacting with graphical user interface elements of a client application.

Aspects of the above method include the method further comprising automatically detecting, with the developer application, each interactive graphical user interface element of the client application prior to recording the user interacting with the graphical user interface elements.

Aspects of the above method include wherein generating the first video clip of the graphical user interface performing the first action comprises automatically generating one or more of mouse movements and text entry.

Aspects of the above method include wherein the first video clip comprises a zoomed-in view of a user interface performing the first action.

Aspects of the above method include wherein the first video clip is generated to be a particular length of time based on metadata associated with the first action.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether such alternate, interchangeable and/or equivalent structures, functions, ranges, or steps are disclosed herein, and without intending to publicly dedicate any patentable subject matter.

What is claimed is:

1. A method of automatically generating a video, the method comprising:
receiving, with a processor of a computer system, a test script;
generating, with the processor, a step action tree comprising a plurality of actions based on the test script;
receiving, with the processor, a selection of a first action of the plurality of actions in the step action tree; and
based on the selection of the first action:
generating, with the processor, a first video clip of a graphical user interface performing the first action; and
associating, with the processor, the first video clip with the first action.

2. The method of claim 1, further comprising generating text for the first action.

3. The method of claim 2, wherein the text is generated using a machine learning algorithm.

4. The method of claim 3, wherein a description of the first action is used as an input to the machine learning algorithm and the text for the first action is an output of the machine learning algorithm.

5. The method of claim 4, further comprising, generating a narration audio clip for the first action.

6. The method of claim 5, wherein the narration audio clip is generated by processing the text for the first action using a text-to-speech engine.

7. The method of claim 6, further comprising appending the narration audio clip to the first video clip.

8. The method of claim 2, further comprising, prior to generating text for the first action, receiving a selection of one or more languages.

9. The method of claim 8, wherein generating text for the first action comprises generating a text string in each of the one or more languages.

10. The method of claim 9, further comprising generating a separate video clip for the first action for each of the one or more languages.

11. The method of claim 1, further comprising determining a plurality of preceding actions based on the selection of the first action.

12. The method of claim 11, further comprising generating a video clip for each of the plurality of preceding actions.

13. The method of claim 12, further comprising generating a video file comprising each video clip for each of the plurality of preceding actions and the first video clip.

14. The method of claim 1, further comprising appending music to the first video clip.

15. The method of claim 1, wherein generating the step action tree comprises recording, with a developer application, a user interacting with graphical user interface elements of a client application.

16. The method of claim 15, further comprising automatically detecting, with the developer application, each interactive graphical user interface element of the client application prior to recording the user interacting with the graphical user interface elements.

17. The method of claim 1, wherein generating the first video clip of the graphical user interface performing the first action comprises automatically generating one or more of mouse movements and text entry.

18. The method of claim 16, wherein the first video clip comprises a zoomed-in view of a user interface performing the first action.

19. A user device comprising:
a processor; and
a computer-readable storage medium storing computer-readable instructions which, when executed by the processor, cause the processor to execute a method for automatically generating a video, the method comprising:
receiving, with a processor of a computer system, a test script;
generating, with the processor, a step action tree comprising a plurality of actions based on the test script;
receiving, with the processor, a selection of a first action of the plurality of actions in the step action tree; and
based on the selection of the first action:
generating, with the processor, a first video clip of a graphical user interface performing the first action; and
associating, with the processor, the first video clip with the first action.

20. A computer program product comprising:
a non-transitory computer-readable storage medium having computer-readable program code embodied therewith, the computer-readable program code configured, when executed by a processor, to execute a method for automatically generating a video, the method comprising:
receiving, with a processor of a computer system, a test script;
generating, with the processor, a step action tree comprising a plurality of actions based on the test script;
receiving, with the processor, a selection of a first action of the plurality of actions in the step action tree; and
based on the selection of the first action:
generating, with the processor, a first video clip of a graphical user interface performing the first action; and
associating, with the processor, the first video clip with the first action.
